(19) United States
(12) Patent Application Publication
(10) Pub. No.: US 2023/0191488 A1
(43) Pub. Date: Jun. 22, 2023

(54) METHOD FOR PRODUCING AN ALUMINIUM ALLOY PART

(71) Applicant: C-TEC Constellium Technology Center, Voreppe (FR)

(72) Inventors: Bechir CHEHAB, Voiron (FR); Ravi SHAHANI, Voreppe (FR)

(21) Appl. No.: 17/995,967

(22) PCT Filed: May 10, 2021
(86) PCT No.: PCT/FR2021/050800

§ 371 Date: Oct. 11, 2022

(30) Foreign Application Priority Data
May 13, 2020 (FR) FR2004723

(51) Int. Cl. B22F 10/28; B22F 1/12

(52) U.S. Cl. CPC B22F 10/28; B22F 1/12; B33Y 10/00

(57) ABSTRACT

The invention relates to a method for producing a part, comprising the production of successive solid metallic layers (201 . . . 20n), each layer being produced by depositing a metal (25) called filler metal, said filler metal consisting of an aluminium alloy comprising at least the following alloying elements:
Zr, in a mass fraction of 0.60 to 1.40%,
Mn, in a mass fraction of 2.00 to 5.00%,
Ni, in a mass fraction of 1.00 to 5.00%,
Cu, in a mass fraction of 1.00 to 5.00%.

The invention also relates to a part obtained by means of the method.

The alloy used in the additive manufacturing method of the invention makes it possible to obtain parts with exceptional properties.

### TECHNICAL FIELD

The technical field of the invention is a method for producing an aluminum alloy part, using an additive manufacturing technique.

### PRIOR ART

Since the 1980s, additive manufacturing techniques have been developed. They consist of forming a part by adding material, which is the opposite of machining techniques, which are aimed at removing material. Previously confined to prototyping, additive manufacturing is now operational for manufacturing mass-produced industrial products, including metallic parts.

The term “additive manufacturing” is defined, as per the French standard XP E67-001, as a set of methods for producing, layer upon layer, by adding material, a physical object from a digital object. The standard ASTM F2792 (January 2012) also defines additive manufacturing. Various additive manufacturing methods are also defined in the standard ISO/ASTM 17296-1. The use of additive manufacturing to produce an aluminum part, with a low porosity, was described in the document WO2015/006447. The application of successive layers is generally carried out by applying a so-called filler material, then melting or sintering the filler material using an energy source such as a laser beam, electron beam, plasma torch or electric arc. Regardless of the additive manufacturing method applied, the thickness of each layer added is of the order of some tens or hundreds of microns.

A means of additive manufacturing is melting or sintering a filler material taking the form of a powder. This may consist of laser melting or sintering using an energy beam.

Selective laser sintering techniques are known (selective laser sintering, SLS or direct metal laser sintering, DMLS), wherein a layer of metal powder or metal alloy is applied on the part to be manufactured and is sintered selectively according to the digital model with thermal energy from a laser beam. A further type of metal formation method comprises selective laser melting (SLM) or electron beam melting (EBM), wherein the thermal energy supplied by a laser or a targeted electron beam is used to selectively melt (instead of sinter) the metallic powder so that it melts as it cools and solidifies.

Laser melting deposition (LMD) is also known, wherein the powder is sprayed and melted by a laser beam simultaneously.

Patent application WO2016/209652 describes a method for producing a high mechanical strength aluminum comprising: preparing an atomized aluminum powder having one or more desired approximate powder sizes and an approximate morphology; sintering the powder to form a product by additive manufacturing; solution heat treatment; quenching; and aging of the aluminum manufactured with an additive process.

There is a growing demand for high-strength aluminum alloys usable at high temperatures for the SLM application. The 4xxx alloys (essentially Al10SiMg, Al7SiMg and Al12Si) are the most mature aluminum alloys for the SLM application. These alloys offer a very good suitability for the SLM method but suffer from limited mechanical properties.

Scalmalloy® (DE102007018123A1) developed by APWorks offers (with a post-manufacturing thermal treatment of 4 h at 325° C.) good mechanical properties at ambient temperature. However, this solution suffers from a high cost in powder form linked with the high scandium content (˜0.7% Sc) thereof and the need for a specific atomization process. This solution also suffers from poor mechanical properties at high temperatures, for example at temperatures greater than 150° C.

Addalloy™ developed by NanoAl (WO201800935A1) is an Al Mg Zr alloy. This alloy suffers from limited mechanical properties at high temperatures.

The 8009 alloy (Al Fe V Si), developed by Honeywell (US201313801662) offers good mechanical properties in the as-manufactured temper both at ambient temperature and at high temperatures up to 350° C. However, the 8009 alloy suffers from processability problems (risk of cracking), probably associated with the substantial hardness thereof in the as-manufactured temper.

The mechanical properties of aluminum parts obtained by additive manufacturing are dependent on the alloy forming the filler metal, and more specifically on the composition thereof, the parameters of the additive manufacturing method as well as the thermal treatments applied. The inventors determined an alloy composition which, used in an additive manufacturing method, makes it possible to obtain parts having remarkable characteristics. In particular, the parts obtained according to the present invention have enhanced characteristics with respect to the prior art, particularly in terms of yield strength at 200° C. and cracking sensitivity during the SLM method.

### DESCRIPTION OF THE INVENTION

The inventors discovered that an optimization of the Zr content, optionally associated with an optimization of the manufacturing temperature (and in particular of the manufacturing plateau), makes it possible to:
eliminate cracking sensitivity problems;
control the yield strength in the as-manufactured temper;
enhance the hardening capacity (difference in mechanical strength at ambient temperature between the as-manufactured temper and the temper after a thermal treatment at approximately 400° C.); and
provide good mechanical performances at ambient temperature and at high temperatures.

The invention firstly relates to a method for producing a part comprising the production of successive solid metallic layers, which are superimposed on each other, each layer describing a pattern defined using a digital model, each layer being produced by depositing a metal, called filler metal, the filler metal being subjected to a supply of energy so as to become molten and to constitute, upon solidifying, said layer, wherein the filler metal takes the form of a powder, the exposure of which to an energy beam results in a melting followed by a solidification, so as to form a solid layer, the method being characterized in that the filler metal is an aluminum alloy comprising at least the following alloy elements:
Zr, in a mass fraction of 0.60 to 1.40%, preferably of 0.70 to 1.30%, preferably of 0.80 to 1.20%, more preferably of 0.85 to 1.15%; even more preferably of 0.90 to 1.10%;
Mn, in a mass fraction of 2.00 to 5.00%, preferably of 3.00 to 5.00%, preferably of 3.50 to 4.50%;
Ni, in a mass fraction of 1.00 to 5.00%, preferably of 2.00 to 4.00%, preferably of 2.50 to 3.50%;
Cu, in a mass fraction of 1.00 to 5.00%, preferably of 1.00 to 3.00%, preferably of 1.50 to 2.50%;
optionally at least one element selected from: Hf, Cr, Ti, Er, W, Nb, Ta, Y, Yb, Nd, Ce, Co, Mo, Lu, Tm, V and/or mischmetal, in a mass fraction less than or equal to 5%, preferably less than or equal to 3.00% each, and less than or equal to 15.00%, preferably less than or equal to 12.00%, even more preferably less than or equal to 5.00% in total;
optionally at least one element selected from: Fe, Si, Mg, Zn, Sc, La, Sr, Ba, Sb, Bi, Ca, P, B, In and/or Sn, in a mass fraction less than or equal to 1.00%, preferably less than or equal to 0.50%, preferably less than or equal to 0.30%, more preferably less than or equal to 0.10%, even more preferably less than or equal to 700 ppm each, and less than or equal to 2.00%, preferably less than or equal to 1.00% in total;
optionally at least one element selected from: Ag in a mass fraction of 0.06 to 1.00%, Li in a mass fraction of 0.06 to 1.00%;
optionally impurities in a mass fraction less than 0.05% each (i.e. 500 ppm) and less than 0.15% in total;
the remainder being aluminum.

Without being bound by theory, the alloys according to the invention seem to be particularly advantageous for having a good compromise between cracking sensitivity and mechanical strength, particularly tensile strength.

As shown in the examples hereinafter, the quantity of Zr seems to be the predominant influencing factor on the cracking sensitivity of the aluminum alloy. It is known by a person skilled in the art that other elements have equivalent effects to those of Zr. Mention can be made of Ti, V, Sc, Hf, Er, Tm, Yb or Lu in particular. Thus, according to an alternative embodiment of the present invention, Zr could be replaced partially by at least one element selected from: Ti, V, Sc, Hf, Er, Tm, Yb and Lu, preferably up to 90% of the mass fraction of Zr.

According to this alternative embodiment of the present invention, the invention secondly relates to a method for producing a part comprising the production of successive solid metallic layers (20₁ . . . 20ₙ), which are superimposed on each other, each layer describing a pattern defined using a digital model (M), each layer being formed by depositing a metal (25), called filler metal, the filler metal being subjected to a supply of energy so as to become molten and to constitute, upon solidifying, said layer, wherein the filler metal takes the form of a powder (25), the exposure of which to an energy beam (32) results in a melting followed by a solidification, so as to form a solid layer (20₁ . . . 20ₙ),

the method being characterized in that the filler metal (25) is an aluminum alloy comprising at least the following alloy elements:
Zr and at least one element selected from: Ti, V, Sc, Hf, Er, Tm, Yb and Lu, in a mass fraction of 0.60 to 1.40%, preferably of 0.70 to 1.30%, preferably of 0.80 to 1.20%, more preferably of 0.85 to 1.15%; even more preferably of 0.90 to 1.10% in total, in the knowledge that Zr represents from 10 to less than 100% of the percentage ranges given hereinabove;
Mn, in a mass fraction of 2.00 to 5.00%, preferably of 3.00 to 5.00%, preferably of 3.50 to 4.50%;
Ni, in a mass fraction of 1.00 to 5.00%, preferably of 2.00 to 4.00%, preferably of 2.50 to 3.50%;
Cu, in a mass fraction of 1.00 to 5.00%, preferably of 1.00 to 3.00%, preferably of 1.50 to 2.50%;
optionally at least one element selected from: Cr, W, Nb, Ta, Y, Nd, Ce, Co, Mo and/or mischmetal, in a mass fraction less than or equal to 5%, preferably less than or equal to 3.00% each, and less than or equal to 15.00%, preferably less than or equal to 12.00%, even more preferably less than or equal to 5.00% in total;
optionally at least one element selected from: Fe, Si, Mg, Zn, La, Sr, Ba, Sb, Bi, Ca, P, B, In and/or Sn, in a mass fraction less than or equal to 1.00%, preferably less than or equal to 0.50%, preferably less than or equal to 0.30%, more preferably less than or equal to 0.10%, even more preferably less than or equal to 700 ppm each, and less than or equal to 2.00%, preferably less than or equal to 1.00% in total;
optionally at least one element selected from: Ag in a mass fraction of 0.06 to 1.00%, Li in a mass fraction of 0.06 to 1.00%;
optionally impurities in a mass fraction less than 0.05% each (i.e. 500 ppm) and less than 0.15% in total;
the remainder being aluminum.

Preferably, the alloy according to the present invention, in particular according to the first and second subject matter of the invention, comprises a mass fraction of at least 80%, more preferably of at least 85% of aluminum.

The melting of the powder can be partial or complete. Preferably, from 50 to 100% of the exposed powder becomes molten, more preferably from 80 to 100%.

Each layer can particularly describe a pattern defined on the basis of a digital model.

The elements Hf, Cr, Ti, Er, W, Nb, Ta, Y, Yb, Nd, Ce, Co, Mo, Lu, Tm, V and mischmetal can cause the formation of dispersoids or fine intermetallic phases, making it possible to increase the hardness of the material obtained. In a manner known to a person skilled in the art, the composition of the mischmetal is generally from about 45 to 50% cerium, 25% lanthanum, 15 to 20% neodymium and 5% praseodymium.

According to an embodiment, the addition of La, Bi, Mg, Er, Yb, Y, Sc and/or Zn is avoided, the preferred mass fraction of each of these elements then being less than 0.05%, and preferably less than 0.01%.

According to a further embodiment, the addition of Fe and/or Si is avoided. However, it is known by a person skilled in the art that these two elements are generally present in common aluminum alloys at contents as defined hereinabove. The contents as described hereinabove can therefore also correspond to impurity contents for Fe and Si.

The elements Ag and Li can act upon the resistance of the material by hardening precipitation or by the effect thereof on the properties of the solid solution.

Optionally, the alloy can also comprise at least one element to refine the grains, for example AlTiC or AlTiB2 (for example in ATSB or AT3B form), according to a quantity less than or equal to 50 kg/ton, preferably less than or equal to 20 kg/ton, even more preferably less than or equal to 12 kg/ton each, and less than or equal to 50 kg/ton, preferably less than or equal to 20 kg/ton in total.

According to an embodiment, the method can include, following the production of the layers:
a thermal treatment typically at a temperature of at least 100° C. and at most 500° C., preferably of 300 to 450° C.;
and/or a hot isostatic compression (HIC).

The thermal treatment can particularly enable stress relieving of the residual stress and/or an additional precipitation of hardening phases.

The HIC treatment can particularly make it possible to enhance the elongation properties and the fatigue properties. The hot isostatic compression can be carried out before, after or instead of the thermal treatment.

Advantageously, the hot isostatic compression is carried out at a temperature of 250° C. to 550° C. and preferably of 300° C. to 450° C., at a pressure of 500 to 3000 bar and for a duration of 0.5 to 10 hours.

According to a further embodiment, adapted to structural hardening alloys, a solution heat treatment followed by a quenching and an aging of the part formed and/or a hot isostatic compression can be carried out. The hot isostatic compression can in this case advantageously replace the solution heat treatment. However, the method according to the invention is advantageous as it needs preferably no solution heat treatment followed by quenching. The solution heat treatment can have a harmful effect on the mechanical strength in certain cases by contributing to growth of dispersoids or fine intermetallic phases. Moreover, on complex-shaped parts, the quenching operation could result in a distortion of the parts, which would limit the primary advantage of the use of additive manufacturing, which is that of obtaining parts directly in the final or almost final form thereof.

According to an embodiment, the method according to the present invention further optionally includes a machining treatment, and/or a chemical, electrochemical or mechanical surface treatment, and/or a tribofinishing. These treatments can be carried out particularly to reduce the roughness and/or enhance the corrosion resistance and/or enhance the resistance to fatigue crack initiation.

Optionally, it is possible to carry out a mechanical deformation of the part, for example after additive manufacturing and/or before the thermal treatment.

Optionally, it is possible to carry out a joining operation with one or more other parts, with known joining methods. Mention can be made for example by way of joining operation of:
bolting, riveting or other mechanical joining methods;
fusion welding;
friction welding;
brazing.

Preferably, the part is produced either at a temperature of 25 to 150° C., preferably of 50 to 130° C., more preferably of 80 to 110° C., or at a temperature of more than 250 to less than 350° C., preferably of 280 to 330° C. This selection of optimized temperatures is described in more detail in the examples hereinafter. There are several means for heating the chamber for producing a part (and therefore the powder bed) with additive manufacturing. Mention can be made for example of a heating construction slab, or heating with a laser, by induction, by heating lamps or by heating elements which can be placed below and/or inside the construction slab, and/or around the powder bed.

According to an embodiment, the method can be a construction method with a high application rate. The application rate can for example be greater than 4 mm³/s, preferably greater than 6 mm³/s, more preferably greater than 7 mm³/s. The application rate is calculated as the product of the scanning speed (in mm/s), the vector deviation (in mm) and the layer thickness (in mm). According to an embodiment, the method can use a laser, and optionally several lasers.

The invention thirdly relates to a metal part, obtained with a method according to the first or second subject matter of the invention.

The invention fourthly relates to a powder comprising, preferably consisting of, an aluminum alloy comprising at least the following alloy elements:
Zr, in a mass fraction of 0.60 to 1.40%, preferably of 0.70 to 1.30%, preferably of 0.80 to 1.20%, more preferably of 0.85 to 1.15%; even more preferably of 0.90 to 1.10%;
Mn, in a mass fraction of 2.00 to 5.00%, preferably of 3.00 to 5.00%, preferably of 3.50 to 4.50%;
Ni, in a mass fraction of 1.00 to 5.00%, preferably of 2.00 to 4.00%, preferably of 2.50 to 3.50%;
Cu, in a mass fraction of 1.00 to 5.00%, preferably of 1.00 to 3.00%, preferably of 1.50 to 2.50%;
optionally at least one element selected from: Hf, Cr, Ti, Er, W, Nb, Ta, Y, Yb, Nd, Ce, Co, Mo, Lu, Tm, V and/or mischmetal, in a mass fraction less than or equal to 5%, preferably less than or equal to 3.00% each, and less than or equal to 15.00%, preferably less than or equal to 12.00%, even more preferably less than or equal to 5.00% in total;
optionally at least one element selected from: Fe, Si, Mg, Zn, Sc, La, Sr, Ba, Sb, Bi, Ca, P, B, In and/or Sn, in a mass fraction less than or equal to 1.00%, preferably less than or equal to 0.50%, preferably less than or equal to 0.30%, more preferably less than or equal to 0.10%, even more preferably less than or equal to 700 ppm each, and less than or equal to 2.00%, preferably less than or equal to 1.00% in total;
optionally at least one element selected from: Ag in a mass fraction of 0.06 to 1.00%, Li in a mass fraction of 0.06 to 1.00%;
optionally impurities in a mass fraction less than 0.05% each (i.e., 500 ppm) and less than
the remainder being aluminum.

The invention fifthly relates to a powder comprising, preferably consisting of, an aluminum alloy comprising at least the following alloy elements:
Zr and at least one element selected from: Ti, V, Sc, Hf, Er, Tm, Yb and Lu, in a mass fraction of 0.60 to 1.40%, preferably of 0.70 to 1.30%, preferably of 0.80 to 1.20%, more preferably of 0.85 to 1.15%; even more preferably of 0.90 to 1.10% in total, in the knowledge that Zr represents from 10 to less than 100% of the percentage ranges given hereinabove;
Mn, in a mass fraction of 2.00 to 5.00%, preferably of 3.00 to 5.00%, preferably of 3.50 to 4.50%;
Ni, in a mass fraction of 1.00 to 5.00%, preferably of 2.00 to 4.00%, preferably of 2.50 to 3.50%;
Cu, in a mass fraction of 1.00 to 5.00%, preferably of 1.00 to 3.00%, preferably of 1.50 to 2.50%;
optionally at least one element selected from: Cr, W, Nb, Ta, Y, Nd, Ce, Co, Mo and/or mischmetal, in a mass fraction less than or equal to 5%, preferably less than or equal to 3.00% each, and less than or equal to 15.00%, preferably less than or equal to 12.00%, even more preferably less than or equal to 5.00% in total;
optionally at least one element selected from: Fe, Si, Mg, Zn, La, Sr, Ba, Sb, Bi, Ca, P, B, In and/or Sn, in a mass fraction less than or equal to 1.00%, preferably less than or equal to 0.50%, preferably less than or equal to 0.30%, more preferably less than or equal to 0.10%, even more preferably less than or equal to 700 ppm each, and less than or equal to 2.00%, preferably less than or equal to 1.00% in total;
optionally at least one element selected from: Ag in a mass fraction of 0.06 to 1.00%, Li in a mass fraction of 0.06 to 1.00%;
optionally impurities in a mass fraction less than 0.05% each (i.e., 500 ppm) and less than 0.15% in total;
the remainder being aluminum.

This fifth subject matter of the invention corresponds to an alternative embodiment of the fourth subject matter of the invention, whereby at least one element selected from the following is used: Ti, V, Sc, Hf, Er, Tm, Yb and Lu, as a partial replacement of Zr, preferably up to 90% of the mass fraction of Zr.

Preferably, the alloy of the powder according to the present invention comprises a mass fraction of at least 80%, more preferably of at least 85% aluminum.

The aluminum alloy of the powder according to the present invention can also comprise one of the following options, alone or in combination:
The addition of La, Bi, Mg, Er, Yb, Y, Sc and/or Zn is avoided, the preferred mass fraction of each of these elements then being less than 0.05%, and preferably less than 0.01%; and/or
The addition of Fe and/or Se is avoided. However, it is known by a person skilled in the art that these two elements are generally present in common aluminum alloys at contents as defined hereinabove. The contents as described hereinabove can therefore also correspond to impurity contents for Fe and Si.; and/or
At least one element is added to refine the grains, for example AlTiC or AlTiB2 (for example in ATSB or AT3B form), according to a quantity less than or equal to 50 kg/ton, preferably less than or equal to 20 kg/ton, even more preferably equal to 12 kg/ton each, and less than or equal to 50 kg/ton, preferably less than or equal to 20 kg/ton in total.

Further advantages and features will emerge more clearly from the following description and from the non-limiting examples, represented in the figures listed below.

### FIGURES

FIG. 1 is a diagram illustrating an SLM, or EBM type additive manufacturing method.

FIG. 2 shows a cracking test specimen as used in the example. Reference 1 corresponds to the face used for metallographic observations, reference 2 to the critical cracking measurement zone, reference 3 to the manufacturing direction.

FIG. 3 is a graph showing the results of the statistical analysis based on the experiment plan of example 1, in order to determine the effects of the addition elements Ni, Cu and Zr on cracking. The y-axis represents the crack length in μm and the x-axis the mass percentage.

FIG. 4 is a test specimen geometry used to perform tensile tests, as used in Example 2.

### DETAILED DESCRIPTION OF THE INVENTION

In the description, unless specified otherwise:
aluminum alloys are designated according to the nomenclature established by the Aluminum Association;
the chemical element contents are designated as a % and represent mass fractions.

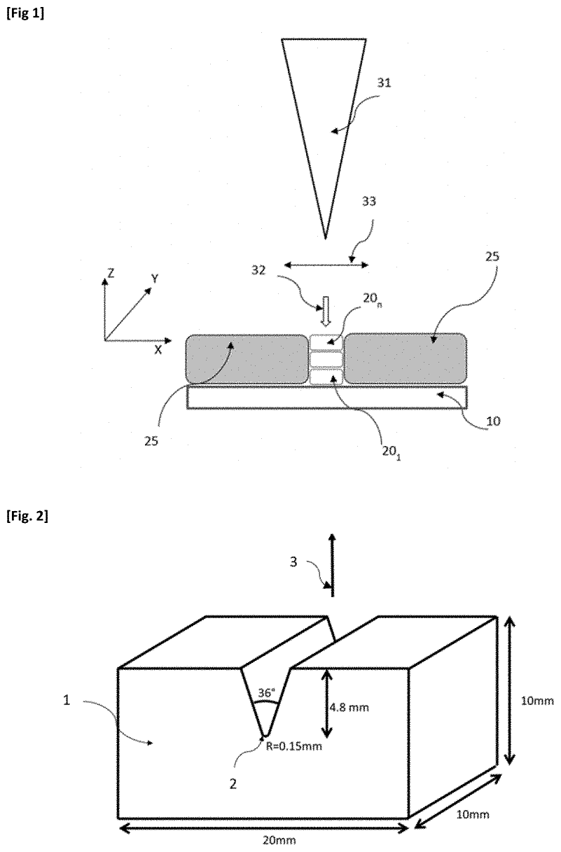

FIG. 1 generally describes an embodiment, wherein the additive manufacturing method according to the invention is used. According to this method, the filler material 25 is presented in the form of an alloy powder according to the invention. An energy source, for example a laser source or an electron source 31, emits an energy beam for example a laser beam or an electron beam 32. The energy source is coupled with the filler material by an optical or electromagnetic lens system 33, the movement of the beam thus being capable of being determined according to a digital model M. The energy beam 32 follows a movement along the longitudinal plane XY, describing a pattern dependent on the digital model M. The powder 25 is deposited on a construction slab 10. The interaction of the energy beam 32 with the powder 25 induces selective melting thereof, followed by a solidification, resulting in the formation of a layer 20₁ . . . 20ₙ. When a layer has been formed, it is coated with filler metal powder 25 and a further layer is formed, superimposed on the layer previously produced. The thickness of the powder forming a layer can for example be from 10 to 200 μm. During manufacture, the powder bed can be heated. This additive manufacturing mode is typically known as selective laser melting (SLM) when the energy beam is a laser beam, the method being in this case advantageously executed at atmospheric pressure, and as electron beam melting (EBM) when the energy beam is an electron beam, the method being in this case advantageously executed at reduced pressure, typically less than 0.01 bar and preferably less than 0.1 mbar.

In a further embodiment, the layer is obtained by selective laser sintering (SLS) or direct metal laser sintering (DMLS), the layer of alloy powder according to the invention being selectively sintered according to the digital model selected with thermal energy supplied by a laser beam. In a further embodiment not described by FIG. 1, the powder is sprayed and melted simultaneously by a generally laser beam. This method is known as laser melting deposition.

Further methods can be used, particularly those known as Direct Energy Deposition (DED), Direct Metal Deposition (DMD), Direct Laser Deposition (DLD), Laser Deposition Technology (LDT), Laser Metal Deposition (LMD), Laser Engineering Net Shaping (LENS), Laser Cladding Technology (LCT), or Laser Freeform Manufacturing Technology (LFMT).

In an embodiment, the method according to the invention is used for producing a hybrid part comprising a portion obtained using conventional rolling and/or extrusion and/or casting and/or forging methods optionally followed by machining and a rigidly connected portion obtained by additive manufacturing. This embodiment can also be suitable for repairing parts obtained using conventional methods.

It is also possible, in an embodiment of the invention, to use the method according to the invention for repairing parts obtained by additive manufacturing.

Following the formation of the successive layers, an unwrought part or part in an as-manufactured temper is obtained.

Preferably, the yield strength of the part in the as-manufactured temper according to the present invention is less than 450 MPa, preferably less than 400 MPa, more preferably from 200 to 400 MPa, and even more preferably from 200 to 350 MPa.

Preferably, the yield strength of a part according to the present invention after a thermal treatment not including a solution heat treatment or quenching operation is greater than the yield strength of the same part in the as-manufactured temper. Preferably, the yield strength of a part according to the present invention after a thermal treatment such as that cited hereinabove is greater than 350 MPa, preferably greater than 400 MPa.

The powder according to the present invention can have at least one of the following features:
mean particle size from 3 to 100 μm, preferably from 5 to 25 μm, or from 20 to 60 μm. The values given signify that at least 80% of the particles have a mean size within the specified range;
spherical shape. The sphericity of a powder can for example be determined using a morphogranulometer;
good castability. The castability of a powder can for example be determined as per the standard ASTM B213 or the standard ISO 4490:2018. According to the standard ISO 4490:2018, the flow time is preferably less than 50 s;
low porosity, preferably from 0 to 5%, more preferably from 0 to 2%, even more preferably from 0 to 1% by volume. The porosity can particularly be determined by scanning electron microscopy or by helium pycnometry (see the standard ASTM B923);
absence or small quantity (less than 10%, preferably less than 5% by volume) of small, so-called satellite, particles (1 to 20% of the mean size of the powder), which adhere to the larger particles.

The powder according to the present invention can be obtained with conventional atomization methods using an alloy according to the invention in liquid or solid form or, alternatively, the powder can be obtained by mixing primary powders before the exposure to the energy beam, the different compositions of the primary powders having an average composition corresponding to the composition of the alloy according to the invention.

It is also possible to add infusible, non-soluble particles, for example oxides or particles of titanium dibromide TiB₂ or particles of titanium carbide TiC, in the bath before atomizing the powder and/or during the deposition of the powder and/or during the mixing of the primary powders. These particles can serve to refine the microstructure. They can also serve to harden the alloy if they are of nanometric size. These particles can be present according to a volume fraction less than 30%, preferably less than 20%, more preferably less than 10%.

The powder according to the present invention can be obtained for example by gas jet atomization, plasma atomization, water jet atomization, ultrasonic atomization, centrifugal atomization, electrolysis and spheroidization, or grinding and spheroidization.

Preferably, the powder according to the present invention is obtained by gas jet atomization. The gas jet atomization method starts with casting a molten metal through a nozzle. The molten metal is then reached by inert gas jets, such as nitrogen or argon, optionally accompanied by other gases, and atomized into very small droplets which are cooled and solidified by falling inside an atomization tower. The powders are then collected in a can. The gas jet atomization method has the advantage of producing a powder having a spherical shape, unlike water jet atomization which produces a powder having an irregular shape. A further advantage of gas jet atomization is a good powder density, particularly thanks to the spherical shape and the particle size distribution. A further advantage of this method is a good reproducibility of the particle size distribution.

After the manufacture thereof, the powder according to the present invention can be oven-dried, particularly in order to reduce the moisture thereof. The powder can also be packaged and stored between the manufacture and use thereof.

The powder according to the present invention can particularly be used in the following applications:
Selective Laser Sintering or SLS;
Direct Metal Laser Sintering or DMLS;
Selective Heat Sintering or SHS;
Selective Laser Melting or SLM;
Electron Beam Melting or EBM;
Laser Melting Deposition;
Direct Energy Deposition or DED;
Direct Metal Deposition or DMD;
Direct Laser Deposition or DLD;
Laser Deposition Technology or LDT;
Laser Engineering Net Shaping or LENS;
Laser Cladding Technology or LCT;
Laser Freeform Manufacturing Technology or LFMT;
Laser Metal Deposition or LMD;
Cold Spray Consolidation or CSC;
Additive Friction Stir or AFS;
Field Assisted Sintering Technology, FAST or spark plasma sintering); or
Inertia Rotary Friction Welding or IRFW.

The invention will be described in more detail in the example hereinafter.

The invention is not limited to the embodiments described in the description above or in the examples hereinafter, and can vary widely within the scope of the invention as defined by the claims attached to the present description.

### EXAMPLES

### Example 1

A study was conducted on four alloys (B, C, D and E) as part of a three-variable Taguchi type experiment plan (% Ni, % Cu and % Zr). The compositions, determined by ICP (Inductively Coupled Plasma) as a mass %, are given in Table 1 hereinafter. These four alloys were obtained in SLM method powder form using gas jet atomization (Ar). The particle size was essentially from 3 μm to 100 μm, D10 was from 8 to 10 μm, D50 from 24 to 28 μm and D90 from 48 to 56 μm.

TABLE 1

| Alloy | % Mn | % Ni | % Cu | % Zr |
|---|---|---|---|---|
| B | 3.57 | 0.00 | 1.97 | 1.30 |
| C | 3.52 | 2.00 | 3.84 | 1.26 |
| D | 3.53 | 0.00 | 3.85 | 1.02 |
| E | 3.56 | 1.94 | 1.97 | 1.00 |

Using an EOS290 type SLM machine (supplier EOS), cracking test specimens were produced with a view to studying the sensitivity of these alloys to cracking.

These test specimens, which are represented in FIG. 2, have a specific geometry having a critical site prone to crack initiation. When printing these test specimens, the main laser parameters used were as follows: laser power of 370 W; scanning speed of 1400 mm/s; vector deviation of 0.11 mm; layer thickness of 60 μm. The EOSM290 machine used makes it possible to heat the construction slab with heating elements up to a temperature of 200° C. Cracking test specimens were printed using this machine with a plateau temperature of 200° C. In all cases, the test specimens underwent a post-manufacture stress relief treatment of 4 hours at 300° C. After manufacture, the test specimens were mechanically polished to 1 μm on the face shown in FIG. 2 (Reference 1). The total length of the crack present on the critical initiation site of the test specimens was measured using an optical microscope with a magnification factor of X50. The results are summarized in Table 2 hereinafter.

TABLE 2

| | Slab heating temperature | Crack length |
|---|---|---|
| Alloy | (° C.) | (μm) |
| B | 200 | 1456 |
| C | 200 | 1609 |
| D | 200 | 1051 |
| E | 200 | 543 |

A statistical analysis of the results from this experiment plan was conducted in the form of graphs of the main effects of the addition elements, as shown in FIG. 3. This graph shows how a factor (here the addition element content) affects the response observed (here the crack length measured on the cracking samples). For this, the mean response for each factor level is calculated and positioned on the graph and a line joins the points of each of the factor levels. When the line is horizontal, there is no main effect (i.e., each factor level affects the measured response in the same way). When the line is not horizontal, there is a main effect (therefore, the two factor levels affect the measured response differently). The greater the slope of this line, the greater the main effect.

The graph in FIG. 3 shows that, on the composition ranges studied, a 1% decrease in Ni induces an increase in the mean cracking length of 90 μm; a 1% decrease in Cu induces a decrease in the mean cracking length of 175 μm and a 1% decrease in Zr induces a decrease in the mean cracking length of 2724 μm.

The results of this example show that on the composition ranges studied, Zr has a predominant effect on cracking. More specifically, a decrease in the Zr content is preferable to limit the sensitivity to cracking.

It is worth noting that, in this example, the inventors deliberately placed themselves in conditions conducive to promoting cracking, in order to be able to effectively compare the impact of the addition elements on the sensitivity to cracking. The use of test specimens with less complex shapes would not have made it possible to be sufficiently discriminatory. Therefore, the present example merely serves to demonstrate the impact of the addition elements on the sensitivity to cracking.

### Example 2

A study was conducted on 6 alloys A, F, G, H, I and J. The compositions of the 6 alloys, determined by ICP (Inductively Coupled Plasma) as a mass %, are given in Table 3 below. These 6 alloys were obtained in SLM method powder form using gas jet atomization (Ar). The particle size was essentially from 3 μm to 100 μm, D10 was from 8 to 36 μm, D50 from 24 to 48 μm and D90 from 48 to 67 μm.

TABLE 3

| Alloy | % Mn | % Ni | % Cu | % Zr |
|---|---|---|---|---|
| A | 3.52 | 2.93 | 1.99 | 1.53 |
| F | 3.77 | 2.77 | 1.90 | 1.02 |
| G | 2.89 | 2.44 | 1.90 | 0.40 |
| H | 3.07 | 4.13 | 1.94 | 0.63 |
| I | 3.97 | 2.51 | 1.95 | 0.66 |
| J | 3.94 | 4.00 | 1.92 | 0.34 |

Cracking test specimens (identical to that from example 1) and cylindrical test specimens (according to the explanations given hereinafter) were produced from the alloys of Table 3 hereinabove.

Using an EOSM290 type SLM machine (supplier EOS), vertical cylindrical samples relative to the direction of construction (Z direction) were produced in order to determine the mechanical characteristics of the alloy. These samples have a diameter of 11 mm and a height of 46 mm. When printing these samples, the main laser parameters used were as follows: laser power of 370 W; scanning speed of 1400 mm/s; vector deviation of 0.11 mm; layer thickness of 60 μm. The manufacturing slab heating temperature was 100° C. In all cases, the samples underwent a post-manufacture stress relief treatment of 4 hours at 300° C.

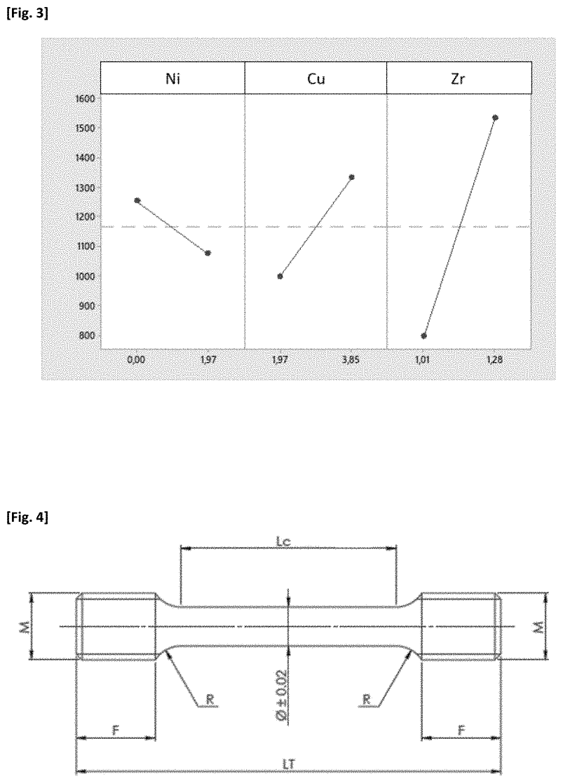

The cylindrical samples were machined to obtain tensile test specimens with the following characteristics, as described in Table 4 hereinafter and FIG. 4.

TABLE 4

| Test specimen | Ø | M | LT | R | Lc | F |
|---|---|---|---|---|---|---|
| type | (mm) | (mm) | (mm) | (mm) | (mm) | (mm) |
| TOR 4 | 4 | 8 | 45 | 3 | 22 | 8.7 |

In Table 4 hereinabove and FIG. 4, Ø represents the diameter of the central portion of the test specimen; M the width of the two ends of the test specimen; LT the total length of the test specimen; R the radius of curvature between the central portion and the ends of the test specimen; Lc the length of the central portion of the test specimen and F the length of the two ends of the test specimen.

The test specimens then underwent a tensile test at ambient temperature (25° C.), in the as-stress relieved temper (with no additional thermal treatment other than stress relief) as per the standard NF EN ISO 6892-1 (2009-10). The main results are shown in Table 5 hereinafter.

TABLE 5

| | | | RP02 measured at |
|---|---|---|---|
| | Slab heating | | 25° C. in MPa on as- |
| | temperature | Crack length | stress relieved |
| Alloy | (° C.) | (μm) | temper |
| A | 100 | 490 | 372 |
| F | 100 | 0 | 303 |
| G | 100 | 0 | 184 |
| H | 100 | 0 | 267 |
| I | 100 | 0 | 235 |
| J | 100 | 0 | 245 |

The results of Table 5 hereinabove show that, for a manufacturing slab temperature of 100° C., a Zr content less than or equal to 1.3% (alloys F to J) made it possible to eliminate cracking completely on the cracking test specimens.

The results of Table 5 also show that an RP02 value in the as-stress relieved temper less than 400 MPa, and preferably less than 370 MPa, would be advantageous for limiting the sensitivity to cracking.

### Example 3

A similar study to that in example 2 was conducted on 5 alloys. The compositions of these 5 alloys, determined by ICP (Inductively Coupled Plasma) as a mass %, are given in Table 6 hereinafter.

These 5 alloys were obtained in SLM method powder form using gas jet atomization (Ar). The particle size was essentially from 3 μm to 100 μm, D10 was from 8 to 36 μm, D50 from 24 to 48 μm and D90 from 48 to 67 μm.

TABLE 6

| Alloy | % Mn | % Ni | % Cu | % Zr |
|---|---|---|---|---|
| F | 3.77 | 2.77 | 1.90 | 1.02 |
| G | 2.89 | 2.44 | 1.90 | 0.40 |
| H | 3.07 | 4.13 | 1.94 | 0.63 |
| I | 3.97 | 2.51 | 1.95 | 0.66 |
| J | 3.94 | 4.00 | 1.92 | 0.34 |

Using an EOSM290 type SLM machine (supplier EOS), vertical cylindrical samples relative to the direction of construction (Z direction) were produced in order to determine the mechanical characteristics of the alloy. These samples have a diameter of 11 mm and a height of 46 mm. When printing these samples, the main laser parameters used were as follows: laser power of 370 W, scanning speed of 1400 mm/s; vector deviation of 0.11 mm; layer thickness of 60 μm. The construction slab was heated to a temperature of 100° C.

In all cases, the samples underwent a post-manufacture stress relief treatment of 4 hours at 300° C.

The cylindrical samples were machined to obtain similar tensile test specimens to that in example 2 hereinabove.

After machining, some test specimens underwent a thermal treatment of 1 h at 400° C. The thermal treatment of 1 h at 400° C. makes it possible to simulate a post-manufacture hot isostatic compression operation or a long-term aging at an operating temperature between 100° C. and 300° C. of the final part.

The test specimens then underwent a tensile test at ambient temperature (25° C.) as per the standard NF EN ISO 6892-1 (2009-10) and at high temperatures (200° C.) as per the standard NF EN ISO 6892-2 (2018). The main results are shown in Table 7 hereinafter.

TABLE 7

| | | Duration | | |
|---|---|---|---|---|
| | Construction | of thermal | | |
| | slab | treatment | Tensile test | |
| | temperature | at 400° C. | temperature | RP02 |
| Alloy | (° C.) | (h) | (° C.) | (MPa) |
| F | 100 | 0 | 25 | 303 |
| G | 100 | 0 | 25 | 184 |
| H | 100 | 0 | 25 | 267 |
| I | 100 | 0 | 25 | 235 |
| J | 100 | 0 | 25 | 245 |
| F | 100 | 1 | 25 | 420 |
| G | 100 | 1 | 25 | 187 |
| H | 100 | 1 | 25 | 291 |
| I | 100 | 1 | 25 | 291 |
| J | 100 | 1 | 25 | 222 |
| F | 100 | 0 | 200 | 270 |
| G | 100 | 0 | 200 | 179 |
| H | 100 | 0 | 200 | 242 |
| I | 100 | 0 | 200 | 218 |
| J | 100 | 0 | 200 | 235 |
| F | 100 | 1 | 200 | 238 |
| G | 100 | 1 | 200 | 175 |
| H | 100 | 1 | 200 | 208 |
| I | 100 | 1 | 200 | 211 |
| J | 100 | 1 | 200 | 192 |

According to Table 7 hereinabove, in the as-stress relieved temper (with no post-manufacture thermal treatment other than stress relief), all of the alloys tested have a yield strength at 25° C. less than 310 MPa, which is beneficial for the processability of the alloys by limiting the level of residual stress during manufacture. The best mechanical properties at ambient temperature after thermal treatment of 1 h at 400° C. are obtained for alloy F (RP02 of 420 MPa) followed by alloys H and I (291 MPa). The poorest performances are obtained for alloys G and J, 187 and 222 MPa, respectively. These results show the positive impact of the Zr content on mechanical performances after hardening treatment. A minimum Zr content of 0.6% is thus required to obtain a minimum RP02 of 250 MPa after thermal treatment of 1 h at 400° C.

For the tensile tests at 200° C., the results of Table 7 hereinabove show that, for all the alloys tested, the as-stress relieved temper is advantageous in relation to the temper with a post-manufacture thermal treatment of 1 h at 400° C.

The thermal treatment of 1 h at 400° C. makes it possible to simulate the effect of very long-term aging at 200° C. The best performances at 200° C. after thermal treatment of 1 h at 400° C. were obtained for alloy F followed by alloys H and I. The poorest performances are once again obtained for alloys G and J (RP02<200 MPa).

A minimum Zr content of 0.6% thus seems to be preferably to obtain a good thermal stability of the mechanical properties at 200° C.

Within the scope of additional tests, not shown here, with the compositions according to the invention on another SLM machine which has a heating slab up to a temperature of 500° C., the inventors demonstrated that a slab temperature of 250 to 350° C., and preferably of 280 to 330° C., also made it possible to prevent cracking on the cracking test specimens, without degrading the mechanical performances at ambient temperature and at 200° C. Surprisingly, despite the increase in the slab temperature, there was no decrease in the mechanical properties in the unwrought temper or after a thermal treatment. Without being bound by theory, it seems that, under these conditions, the alloys according to the present invention make it possible to retain a good ability to trap the addition elements in solid solution, and especially Zr. An additional increase in the slab temperature, for example to 400° C. or to 500° C., seems to make it possible to reduce the solidification rate during the SLM method and thus limit the trapping of Zr in solid solution, which seems to degrade the mechanical properties in the unwrought temper, and the ability of the alloys for additional hardness during post-manufacture heat treatments, for example at 400° C. In conclusion, the slab temperature range which seems to maximize cracking sensitivity is located between 150° C. and 250° C.

Thus, the temperature ranges of the construction slab recommended according to the present invention are either from 25 to 150° C., preferably from 50 to 130° C., more preferably from 80 to 110° C., i.e., at a temperature from more than 250 to less than 350° C., preferably from 280 to 330° C.

1. A method for producing a part comprising production of successive solid metallic layers, which are superimposed on each other, each layer describing a pattern defined using a digital model, each layer being produced by depositing a metal, called filler metal, the filler metal being subjected to a supply of energy so as to become molten and to constitute, upon solidifying, said layer, wherein the filler metal takes the form of a powder, the exposure of which to an energy beam results in a melting followed by a solidification, so as to form a solid layer,
wherein the filler metal is an aluminum alloy comprising at least the following alloy elements:
Zr, in a mass fraction of 0.60 to 1.40%, optionally of 0.70 to 1.30%, optionally of 0.80 to 1.2%, optionally of 0.85 to 1.15%; optionally of 0.90 to 1.10%;
Mn, in a mass fraction of 2.00 to 5.00%, optionally of 3.00 to 5.00%, optionally of 3.50 to 4.50%;
Ni, in a mass fraction of 1.00 to 5.00%, optionally of 2.00 to 4.00%, optionally of 2.50 to 3.50%;
Cu, in a mass fraction of 1.00 to 5.00%, optionally of 1.00 to 3.00%, optionally of 1.50 to 2.50%;
optionally at least one element selected from: Hf, Cr, Ti, Er, W, Nb, Ta, Y, Yb, Nd, Ce, Co, Mo, Lu, Tm, V and/or mischmetal, in a mass fraction less than or equal to 5%, optionally less than or equal to 3.00% each, and less than or equal to 15.00%, optionally less than or equal to 12.00%, optionally less than or equal to 5.00% in total;
optionally at least one element selected from: Fe, Si, Mg, Zn, Sc, La, Sr, Ba, Sb, Bi, Ca, P, B, In and/or Sn, in a mass fraction less than or equal to 1.00%, optionally less than or equal to 0.50%, optionally less than or equal to 0.30%, optionally less than or equal to 0.10%, optionally less than or equal to 700 ppm each, and less than or equal to 2.00%, optionally less than or equal to 1.00% in total;
optionally at least one element selected from: Ag in a mass fraction of 0.06 to 1.00%, Li in a mass fraction of 0.06 to 1.00%;
optionally impurities in a mass fraction less than 0.05% each optionally 500 ppm and less than 0.15% in total;
remainder being aluminum.

2. A method for producing a part comprising production of successive solid metallic layers, which are superimposed on each other, each layer describing a pattern defined using a digital model, each layer being produced by depositing a metal, called filler metal, the filler metal being subjected to a supply of energy so as to become molten and to constitute, upon solidifying, said layer, wherein the filler metal takes the form of a powder, the exposure of which to an energy beam results in a melting followed by a solidification, so as to form a solid layer,
wherein the filler metal is an aluminum alloy comprising at least the following alloy elements:
Zr and at least one element selected from: Ti, V, Sc, Hf, Er, Tm, Yb and Lu, in a mass fraction of 0.60 to 1.40%, optionally of 0.70 to 1.30%, optionally of 0.80 to 1.20%, optionally of 0.85 to 1.15%; optionally of 0.90 to 1.10% in total, wherein Zr represents from 10 to less than 100% of the percentage ranges given hereinabove;
Mn, in a mass fraction of 2.00 to 5.00%, optionally of 3.00 to 5.00%, optionally of 3.50 to 4.50%;
Ni, in a mass fraction of 1.00 to 5.00%, optionally of 2.00 to 4.00%, optionally of 2.50 to 3.50%;
Cu, in a mass fraction of 1.00 to 5.00%, optionally of 1.00 to 3.00%, optionally of 1.50 to 2.50%;
optionally at least one element selected from: Cr, W, Nb, Ta, Y, Nd, Ce, Co, Mo and/or mischmetal, in a mass fraction less than or equal to 5%, optionally less than or equal to 3.00% each, and less than or equal to 15.00%, optionally less than or equal to 12.00%, optionally less than or equal to 5.00% in total;
optionally at least one element selected from: Fe, Si, Mg, Zn, La, Sr, Ba, Sb, Bi, Ca, P, B, In and/or Sn, in a mass fraction less than or equal to 1.00%, optionally less than or equal to 0.50%, optionally less than or equal to 0.30%, optionally less than or equal to 0.10%, optionally less than or equal to 700 ppm each, and less than or equal to 2.00%, optionally less than or equal to 1.00% in total;
optionally at least one element selected from: Ag in a mass fraction of 0.06 to 1.00%, Li in a mass fraction of 0.06 to 1.00%;
optionally impurities in a mass fraction less than 0.05% each optionally 500 ppm and less than 0.15% in total;
remainder being aluminum.

3. The method according to claim 1, wherein the addition of La, Bi, Mg, Er, Yb, Y, Sc and/or Zn is avoided, an optional mass fraction of each of these elements then being less than 0.05%, and optionally less than 0.01%.

4. The method according to claim 1, wherein the aluminum alloy also comprises at least one element to refine grains, optionally AlTiC or AlTiB2, according to a quantity less than or equal to 50 kg/ton, optionally less than or equal to 20 kg/ton, optionally less than or equal to 12 kg/ton each, and less than or equal to 50 kg/ton, optionally less than or equal to 20 kg/ton in total.

5. The method according to claim 1, including, following the formation of the layers,
a thermal treatment optionally at a temperature of at least 100° C. and at most 500° C., optionally from 300 to 450° C.; and/or,
a hot isostatic compression.

6. The method according to claim 1 wherein the part is manufactured either at a temperature from 25 to 150° C., optionally from 50 to 130° C., optionally from 80 to 110° C., or at a temperature from more than 250 to less than 350° C., optionally from 280 to 330° C.

7. A metal part obtained by a method according to claim 1.

8. A powder comprising an aluminum alloy comprising at least the following alloy elements;
Zr, in a mass fraction of 0.60 to 1.40%, optionally of 0.70 to 1.30%, optionally of 0.80 to 1.20%, optionally of 0.85 to 1.15%; optionally of 0.90 to 1.10%;
Mn, in a mass fraction of 2.00 to 5.00%, optionally of 3.00 to 5.00%, optionally of 3.50 to 4.50%;
Ni, in a mass fraction of 1.00 to 5.00%, optionally of 2.00 to 4.00%, optionally of 2.50 to 3.50%;
Cu, in a mass fraction of 1.00 to 5.00%, optionally of 1.00 to 3.00%, optionally of 1.50 to 2.50%;
optionally at least one element selected from: Hf, Cr, Ti, Er, W, Nb, Ta, Y, Yb, Nd, Ce, Co, Mo, Lu, Tm, V and/or mischmetal, in a mass fraction less than or equal to 5%, optionally less than or equal to 3.00% each, and less than or equal to 15.00%, optionally less than or equal to 12.00%, optionally less than or equal to 5.00% in total;
optionally at least one element selected from: Fe, Si, Mg, Zn, Sc, La, Sr, Ba, Sb, Bi, Ca, P, B, In and/or Sn, in a mass fraction less than or equal to 1.00%, optionally less than or equal to 0.50%, optionally less than or equal to 0.30%, optionally less than or equal to 0.10%, optionally less than or equal to 700 ppm each, and less than or equal to 2.00%, optionally less than or equal to 1.00% in total;
optionally at least one element selected from: Ag in a mass fraction of 0.06 to 1.00%, Li in a mass fraction of 0.06 to 1.00%;
optionally impurities in a mass fraction less than 0.05% each optionally 500 ppm and less than 0.15% in total;
remainder being aluminum.

9. A powder comprising an aluminum alloy comprising at least the following alloy elements;
Zr and at least one element selected from: Ti, V, Sc, Hf, Er, Tm, Yb and Lu, in a mass fraction of 0.60 to 1.40%, optionally of 0.70 to 1.30%, optionally of 0.80 to 1.20%, optionally of 0.85 to 1.15%; optionally of 0.90 to 1.10% in total, in the knowledge that Zr represents from 10 to less than 100% of the percentage ranges given hereinabove;
Mn, in a mass fraction of 2.00 to 5.00%, optionally of 3.00 to 5.00%, optionally of 3.50 to 4.50%;
Ni, in a mass fraction of 1.00 to 5.00%, optionally of 2.00 to 4.00%, optionally of 2.50 to 3.50%;
Cu, in a mass fraction of 1.00 to 5.00%, optionally of 1.00 to 3.00%, optionally of 1.50 to 2.50%:
optionally at least one element selected from: Cr, W, Nb, Ta, Y, Nd, Ce, Co, Mo and/or mischmetal, in a mass fraction less than or equal to 5.00%, optionally less than or equal to 3.00% each, and less than or equal to 15.00%, optionally less than or equal to 12.00%, optionally less than or equal to 5.00% in total;
optionally at least one element selected from Fe, Si, Mg, Zn, La, Sr, Ba, Sb, Bi, Ca, P, B, In and/or Sn, in a mass fraction less than or equal to 1.00%, optionally less than or equal to 0.50%, optionally less than or equal to 0.30%, optionally less than or equal to 0.10%, optionally less than or equal to 700 ppm each, and less than or equal to 2.00%, optionally less than or equal to 1.00% in total;
optionally at least one element selected from: Ag in a mass fraction of 0.06 to 1.00%, Li in a mass fraction of 0.06 to 1.00%;
optionally impurities in a mass fraction less than 0.05% each optionally 500 ppm and less than 0.15% in total;
remainder being aluminum.
